(19) United States
(12) Patent Application Publication
(10) Pub. No.: US 2026/0259937 A1
(43) Pub. Date: Sep. 3, 2026

(54) Data Sharding Method and Apparatus, and Computing Device

(71) Applicant: Huawei Cloud Computing Technologies Co., Ltd., Guizhou (CN)

(72) Inventors: Kai Zeng, Hangzhou (CN); Kai Zheng, Guizhou (CN); Xu Chen, Guizhou (CN); Timur Timirkaevich Safin, Moscow (RU); Alexander Levshin, Moscow (RU)

(73) Assignee: Huawei Cloud Computing Technologies Co., Ltd., Guizhou (CN)

(21) Appl. No.: 19/657,468

(22) Filed: Apr. 24, 2026

Related U.S. Application Data
(63) Continuation of application No. PCT/RU2024/000034, filed on Feb. 2, 2024.

(30) Foreign Application Priority Data
Oct. 25, 2023 (RU) RU2023127346

(51) Int. Cl. G06F 16/9035; G06N 3/0455

(52) U.S. Cl. CPC G06F 16/9035; G06N 3/0455

(57) ABSTRACT

A data sharding method includes obtaining a plurality of pieces of stored data, and inputting the plurality of pieces of data into a ranking model to obtain a score corresponding to each piece of data, where input information of the ranking model includes the plurality of pieces of data, output information of the ranking model includes the score corresponding to each piece of data, the ranking model is determined based on the plurality of pieces of data and at least one query command, and the query command is used to query target data from the plurality of pieces of data. The method further includes determining, based on the score corresponding to each piece of data, file blocks respectively corresponding to the plurality of pieces of data.

### CROSS-REFERENCE TO RELATED APPLICATIONS

This is a continuation of International Patent Application No. PCT/RU2024/000034 filed on Feb. 2, 2024, which claims priority to Russian Patent Application No. 2023127346 filed on Oct. 25, 2023 both of which are hereby incorporated by reference.

### TECHNICAL FIELD

This disclosure relates to the database field, and, to a data sharding method and apparatus, and a computing device.

### BACKGROUND

A database may be understood as a warehouse that organizes, stores, and manages data based on a data structure. The database is a collection of a large amount of organized data that is stored in a computer, can be shared, and is centrally managed. In the database, data sharding is to arrange data in the database on a memory (for example, a disk) in a specific order, that is, an arrangement order of the data in the database on the memory (for example, the disk).

In a related data sharding solution, a ranking key needs to be manually specified by experience, and a storage order of data in a storage module needs to be determined based on the ranking key. In this solution, the storage order of the data in the storage module needs to be determined by experience. As a result, a scan cost is relatively high, and a query speed and query efficiency in a database are relatively low.

Therefore, how to improve the query speed and query efficiency in the database becomes an urgent technical problem to be resolved.

### SUMMARY

This disclosure provides a data sharding method. The method can improve a query speed and query efficiency of a database.

According to a first aspect, a data sharding method is provided, where the method includes obtaining a plurality of pieces of stored data, inputting the plurality of pieces of data into a ranking model to obtain a score corresponding to each piece of data, where input information of the ranking model includes the plurality of pieces of data, output information of the ranking model includes the score corresponding to each piece of data, the ranking model is determined based on the plurality of pieces of data and at least one query command, and the query command is used to query target data from the plurality of pieces of data, and determining, based on the score corresponding to each piece of data, file blocks respectively corresponding to the plurality of pieces of data.

In the foregoing technical solution, an artificial intelligence (AI) technology is used to perform adaptive sharding on data stored in a memory, so as to provide a file sharding manner corresponding to the stored data, such that when data in a database is queried again using a query command, a scan cost can be reduced, and data skipping efficiency can be improved, thereby improving a query speed and query efficiency of the database.

With reference to the first aspect, in some implementations of the first aspect, the method further includes obtaining the at least one query command and sample data, where the sample data is obtained by sampling the plurality of pieces of stored data, and obtaining the ranking model through training based on the at least one query command and the sample data.

In the foregoing technical solution, a ranking model is trained based on a scan cost of data based on at least one query command, and a trained ranking model can be obtained when the scan cost is the lowest. When a score of each piece of stored data is obtained using the trained ranking model, and data sharding is performed on the plurality of pieces of data based on the score, the plurality of pieces of data may be more aggregated into file blocks, such that subsequent scan cost is the lowest.

With reference to the first aspect, in some implementations of the first aspect, the method further includes compressing the plurality of pieces of data to obtain a plurality of corresponding dimensionality reduction data, and inputting the plurality of pieces of dimensionality reduction data into the ranking model to obtain the score corresponding to each piece of data.

In the foregoing technical solution, dimensionality reduction may be performed through compression on the data input to the ranking model, such that high-dimensional data can be adapted.

With reference to the first aspect, in some implementations of the first aspect, the plurality of pieces of data are input into a compression model to obtain the plurality of pieces of dimensionality reduction data, where input information of the compression model includes the plurality of pieces of data, and output information of the compression model includes the plurality of pieces of dimensionality reduction data.

With reference to the first aspect, in some implementations of the first aspect, the method further includes obtaining the compression model through training based on the sample data.

With reference to the first aspect, in some implementations of the first aspect, the compression model is a variational autoencoder VAE.

With reference to the first aspect, in some implementations of the first aspect, the method is applied to a cloud management platform, the cloud management platform is configured to manage infrastructure that provides a cloud service, the infrastructure includes at least one cloud data center, at least one server is disposed in each cloud data center, and the at least one server is configured to train the ranking model and the compression model.

According to a second aspect, a data sharding apparatus is provided, where the apparatus includes an obtaining module and a processing module. The obtaining module is configured to obtain a plurality of pieces of stored data. The processing module is configured to input the plurality of pieces of data into a ranking model to obtain a score corresponding to each piece of data, where input information of the ranking model includes the plurality of pieces of data, output information of the ranking model includes the score corresponding to each piece of data, the ranking model is determined based on the plurality of pieces of data and at least one query command, and the query command is used to query target data from the plurality of pieces of data. The processing module is further configured to determine, based on the score corresponding to each piece of data, file blocks respectively corresponding to the plurality of pieces of data.

With reference to the second aspect, in some implementations of the second aspect, the apparatus further includes a training module, where the obtaining module is further configured to obtain the at least one query command and sample data, where the sample data is obtained by sampling the plurality of pieces of stored data, and the training module is configured to obtain the ranking model through training based on the at least one query command and the sample data.

With reference to the second aspect, in some implementations of the second aspect, the apparatus further includes a compression module, configured to compress the plurality of pieces of data to obtain a plurality of corresponding dimensionality reduction data, where the processing module is configured to input the plurality of pieces of dimensionality reduction data into the ranking model to obtain the score corresponding to each piece of data.

With reference to the second aspect, in some implementations of the second aspect, the compression module is configured to input the plurality of pieces of data into a compression model to obtain the plurality of pieces of dimensionality reduction data, where input information of the compression model includes the plurality of pieces of data, and output information of the compression model includes the plurality of pieces of dimensionality reduction data.

With reference to the second aspect, in some implementations of the second aspect, the training module is further configured to obtain the compression model through training based on the sample data.

With reference to the second aspect, in some implementations of the second aspect, the compression model is a variational autoencoder VAE.

With reference to the second aspect, in some implementations of the second aspect, the apparatus is applied to a cloud management platform, the cloud management platform is configured to manage infrastructure that provides a cloud service, the infrastructure includes at least one cloud data center, at least one server is disposed in each cloud data center, and the at least one server is configured to train the ranking model and the compression model.

It should be understood that beneficial effects corresponding to the second aspect and the implementations thereof are corresponding to beneficial effects of the first aspect and the implementations thereof. For details, refer to the beneficial effects of the first aspect and the implementations thereof. Details are not described herein again.

According to a third aspect, a computing device is provided, including a processor and a memory, and optionally, further including an input/output interface. The processor is configured to control the input/output interface to receive and send information. The memory is configured to store a computer program. The processor is configured to invoke the computer program from the memory and run the computer program, such that the computing device performs the method according to any one of the first aspect or the possible implementations of the first aspect.

Optionally, the processor may be a general-purpose processor and may be implemented using hardware or software. When the processor is implemented using hardware, the processor may be a logic circuit, an integrated circuit, or the like. When the processor is implemented using software, the processor may be a general-purpose processor and is implemented by reading software code stored in the memory. The memory may be integrated into the processor or may be located outside the processor and exist independently.

According to a fourth aspect, a computing device cluster is provided, including at least one computing device, where each computing device includes a processor and a memory, and the processor of the at least one computing device is configured to execute instructions stored in the memory of the at least one computing device, such that the computing device cluster performs the method according to any one of the first aspect or the possible implementations of the first aspect.

According to a fifth aspect, a chip is provided, where the chip obtains instructions and executes the instructions to implement the method according to any one of the first aspect or the implementations of the first aspect.

Optionally, in an implementation, the chip includes a processor and a data interface. The processor reads, through the data interface, instructions stored in a memory, to implement the method in the first aspect or any one of the implementations of the first aspect.

The processor is configured to execute the instructions stored in the memory. When the instructions are executed, the processor is configured to implement the method in the first aspect or any one of the implementations of the first aspect.

According to a sixth aspect, a computer program product including instructions is provided, where when the instructions are run by a computing device, the computing device is enabled to perform the method according to any one of the first aspect or the implementations of the first aspect.

According to a seventh aspect, a computer program product including instructions is provided, where when the instructions are run by a computing device cluster, the computing device cluster is enabled to perform the method according to any one of the first aspect or the implementations of the first aspect.

According to an eighth aspect, a computer-readable storage medium is provided, including computer program instructions, where when the computer program instructions are executed by a computing device, the computing device performs the method according to any one of the first aspect or the implementations of the first aspect.

In an example, the computer-readable storage medium includes but is not limited to one or more of the following: a read-only memory (ROM), a programmable ROM (PROM), an erasable PROM (EPROM), a flash memory, an electrically EPROM (EEPROM), and a hard drive.

Optionally, in an implementation, the foregoing storage medium may be a non-volatile storage medium.

According to a ninth aspect, a computer-readable storage medium is provided, including computer program instructions, where when the computer program instructions are executed by a computing device cluster, the computing device cluster performs the method according to any one of the first aspect or the implementations of the first aspect.

In an example, the computer-readable storage includes but is not limited to one or more of the following: a ROM, a PROM, an EPROM, a flash memory, an EEPROM, and a hard drive.

Optionally, in an implementation, the foregoing storage medium may be a non-volatile storage medium.

### BRIEF DESCRIPTION OF DRAWINGS

FIG. 1 is a schematic block diagram of a training phase and an inference phase of an AI model applied to an embodiment of this disclosure;

FIG. 2 is a schematic diagram of a disclosure scenario according to an embodiment of this disclosure;

FIG. 3 is a schematic flowchart of a data sharding method according to an embodiment of this disclosure;

FIG. 4 is a schematic block diagram of obtaining a data score according to an embodiment of this disclosure;

FIG. 5 is a schematic block diagram of training a compression model and a ranking model based on original data in a storage module and/or using a query command of the original data according to an embodiment of this disclosure;

FIG. 6 is a schematic block diagram of training a compression model based on original data according to an embodiment of this disclosure;

FIG. 7 is a schematic block diagram of training a ranking model for original data using a query command of the original data according to an embodiment of this disclosure;

FIG. 8 is a schematic diagram of calculating a scan cost for ranked data according to an embodiment of this disclosure;

FIG. 9 is a schematic diagram of a model architecture according to an embodiment of this disclosure;

FIG. 10 is a schematic diagram of False Positive reduction according to an embodiment of this disclosure;

FIG. 11 is a schematic block diagram of a data sharding apparatus 1100 according to an embodiment of this disclosure;

FIG. 12 is a schematic diagram of an architecture of a computing device 1500 according to an embodiment of this disclosure;

FIG. 13 is a schematic diagram of an architecture of a computing device cluster according to an embodiment of this disclosure; and

FIG. 14A and FIG. 14B are a schematic diagram of connecting computing devices 1500A and 1500B using a network according to an embodiment of this disclosure.

### DESCRIPTION OF EMBODIMENTS

The following describes technical solutions of this disclosure with reference to accompanying drawings.

Each aspect, embodiment, or feature is presented in this disclosure with reference to a system including a plurality of devices, components, modules, and the like. It should be appreciated and understood that each system may include another device, component, module, and the like, and/or may not include all devices, components, modules, and the like discussed with reference to the accompanying drawings. In addition, a combination of these solutions may also be used.

In addition, in embodiments of this disclosure, terms such as “example” and “for example” represent giving an example, an illustration, or a description. Any embodiment or design solution described as an “example” in this disclosure should not be explained as being more preferred or having more advantages than another embodiment or design solution. Exactly, the term “example” is used to present a concept in a specific manner.

In embodiments of this disclosure, “relevant (corresponding)” and “corresponding” may sometimes be used interchangeably. It should be noted that meanings to be expressed by the two are consistent when a difference between them is not emphasized.

Service scenarios described in embodiments of this disclosure are intended to describe the technical solutions in embodiments of this disclosure more clearly, and do not constitute a limitation on the technical solutions provided in embodiments of this disclosure. A person of ordinary skill in the art may know that: With evolution of the network architecture and emergence of new service scenarios, the technical solutions provided in embodiments of this disclosure are also applicable to similar technical problems.

Reference to “an embodiment”, “some embodiments”, or the like described in this specification indicates that one or more embodiments of this disclosure include a specific feature, structure, or characteristic described with reference to the embodiments. Therefore, statements such as “in an embodiment”, “in some embodiments”, “in some other embodiments”, and “in other embodiments” that appear at different places in this specification do not necessarily refer to a same embodiment. Instead, the statements mean “one or more but not all of embodiments”, unless otherwise emphasized in another manner. The terms “include”, “include”, and “have”, and variants thereof all mean “include but are not limited to”, unless otherwise emphasized in another manner.

In this disclosure, “at least one” means one or more, and “a plurality of” means two or more. The term “and/or” describes an association relationship for describing associated objects and represents that three relationships may exist. For example, A and/or B may represent the following cases: Only A exists, both A and B exist, and only B exists, where A and B may be singular or plural. The character “/” generally indicates an “or” relationship between the associated objects. “At least one of” or other similar expressions represent any combination of these items, including any combination of a singular or a plural. For example, at least one of a, b, or c may represent a, b, c, a and b, a and c, b and c, or a, b, and c, where a, b, and c may be singular or plural.

For ease of description, the following first describes concepts in embodiments of this disclosure.

### 1. Database

The database may be understood as a warehouse that organizes, stores, and manages data based on a data structure. The database is a collection of a large amount of organized data that is stored in a computer, can be shared, and is centrally managed. One database may include a plurality of table spaces.

### 2. Data Sharding

In a database, data sharding is to arrange data in the database on a memory (for example, a disk) in a specific order, that is, an arrangement order of the data in the database on the memory (for example, the disk). In the database, common data sharding methods include the following:
A. Random sharding: Equal-sized random sharding is performed on a data table.
B. Range-based sharding: Sharding is performed on a data table according to a specific rule, for example, a range of a specified column, or based on time when data is inserted.
C. Sharding is performed according to a spatial filling curve.

### 3. Data Skipping

Data skipping is usually to skip some irrelevant data records or data blocks during data reading, so as to reduce an amount of to-be-processed data or improve a processing speed. In a database, data skipping may involve use of a filter or filter criteria to select only desired data records, or use of indexes to skip unwanted data blocks. In big data processing, data skipping may involve use of techniques such as sampling, filtering, or partitioning to reduce the amount of to-be-processed data.

That is, data skipping is a technology that improves a query speed by reducing an amount of unnecessary input/output (I/O). During data writing, data skipping information of data is automatically collected, and the information (minimum and maximum values) is used to implement faster query. Data skipping is query optimization for a filter clause. During data skipping, statistical information is used to search for a to-be-queried data file set.

### 4. Artificial Intelligence (AI)

AI is using a digital computer or a machine controlled by the digital computer to simulate and extend human intelligence, sense an environment, obtain knowledge, and use the knowledge to obtain an optimal theory, method, technology, and application system. In other words, AI is a branch of computer science and is intended to understand essence of intelligence and produce a new intelligent machine that can react in a manner similar to human intelligence. AI is to research design principles and implementation methods of various intelligent machines, such that the machines have perception, inference, and decision-making functions. Research in the AI field includes robotics, natural language processing, computer vision, decision-making and inference, human-machine interaction, recommendation and search, AI basic theories, and the like.

A basic principle of AI is to combine massive data with powerful computing and processing capabilities and intelligent algorithms to build an AI model for resolving specific problems. In this way, the AI model can automatically summarize and learn latent patterns or features from the data, to achieve a way of thinking similar to that of humans.

An AI model, that is, an AI algorithm (or an AI operator), is a collective term for mathematical algorithms built based on the principle of AI and is the basis for resolving specific problems through AI. Based on different specific methods and/or technologies for implementing AI, the AI model may also be referred to as a machine learning model, a deep learning model, or a reinforcement learning model.

Machine learning is a method for implementing AI, which aims at designing and analyzing some algorithms (that is, models) that enable a computer to automatically “learn”. The designed algorithm is referred to as a machine learning model. The machine learning model is an algorithm used to automatically analyze data to obtain a rule and use the rule to predict unknown data. There are various machine learning models based on whether model training needs to depend on a label corresponding to training data.

Deep learning is a new technical field generated during machine learning research. Deep learning is a method for performing deep data representation learning in machine learning. Deep learning is to interpret data by establishing a neural network that simulates a human brain to perform analysis and learning. In the AI field, deep learning is a learning technology based on a deep neural network algorithm. A deep learning model includes an input layer, a hidden layer, and an output layer, and processes data using a plurality of nonlinear transformations. In the machine learning method, almost all features need to be determined by industry experts before being encoded. However, the deep learning algorithm attempts to learn features from data. An algorithm designed based on the idea of deep learning is referred to as a deep learning model.

An example structure of a deep learning model is a deep neural network. A neural network is a mathematical model or computing model that simulates a structure and a function of a biological neural network (a central nervous system of an animal, especially a brain). In the neural network, a large quantity of neurons are connected to perform calculation. One neural network may include a plurality of neural network layers with different functions, and each layer includes parameters and calculation rules. Different layers in the neural network have different names based on different calculation formulas or different functions. For example, a layer for convolution calculation is referred to as a convolutional layer. The convolutional layer is commonly used to perform feature extraction on an input signal (for example, an image). One neural network may alternatively include a combination of a plurality of sub-neural networks. Neural network models of different structures may be used in different scenarios (for example, classification and recognition), or achieve different effects when being used in a same scenario. That structures of neural networks are different includes one or more of the following: quantities of network layers in the neural networks are different, sequences of the network layers are different, or weights, parameters, or calculation formulas of the network layers are different. The industry has proposed a plurality of different accurate neural networks that are used in disclosure scenarios such as recognition or classification. After being trained using a data set, some neural networks may be separately used to complete a task, or complete a task in combination with another neural network (or another functional module).

In other words, the deep learning model is actually a machine learning model with a complex neural network structure. Based on whether the deep learning model needs to depend on a label corresponding to training data during training, the deep learning model may also be classified into a supervised learning model and unsupervised learning model. Details are not described herein. Typical deep learning models include a convolutional neural network (CNN), a recurrent neural network, a recursive neural network, and the like.

Any AI model needs to be trained before being used to resolve a technical problem. AI model training is a process in which a specified initial model is used to calculate training data, and parameters in the initial model are adjusted using a method based on a calculation result, such that the model gradually learns a specific rule and has a specific function. A trained AI model with a stable function can be used for inference. AI model inference is a process of calculating input data using the trained AI model to obtain a prediction result.

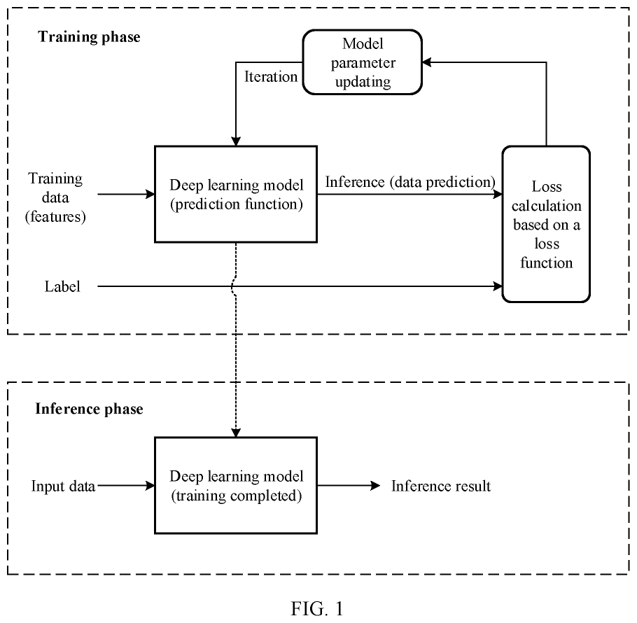

As shown in FIG. 1, in a training phase, a training set for a deep learning model first needs to be constructed based on a target. The training set includes a plurality of pieces of training data, and a label is set for each piece of training data. The label of the training data is a correct answer to a question of the training data, and the label may represent a target of training the deep learning model using the training data. For example, for a deep learning model that can be trained to identify different animals, the training set may include images (that is, training data) of a plurality of different animals, and each image may have a label that identifies a type of an animal (for example, a cat or a dog) included in the image. In this example, the type of animal corresponding to each image is a label of the training data.

When the deep learning model is trained, training data may be input in batches into a deep learning model obtained after parameter initialization, and the deep learning model performs calculation (that is, inference) on the training data to obtain a prediction result for the training data. The prediction result obtained through inference and the label corresponding to the training data are used as lost data used for calculation based on a loss function. The loss function is a function used to calculate, in a model training phase, a difference (that is, a loss value loss) between a prediction result of the model for training data and a label of the training data. The loss function may be implemented using different mathematical functions. Common expressions of the loss function include a mean square error loss function, a logarithmic loss function, a least square method, and the like.

A loss value obtained through calculation based on a loss function may be used to update parameters of the deep learning model. A parameter update manner is usually a gradient descent method. Model training is a process of repeated iteration. In each iteration, inference is performed on different training data, and a loss value is calculated. An objective of a plurality of iterations is to continuously update parameters of the deep learning model and find a parameter configuration that minimizes or tends to stabilize the loss value of the loss function.

In a training phase, to improve training efficiency of a model and performance of a model after training, some proper hyperparameters need to be set for training. Hyperparameters of a deep learning model are a type of parameters that cannot be obtained by learning training data in a training process or that cannot change due to driving of the training data and is a concept relative to parameters in a model. The hyperparameters of the deep learning model are usually manually set based on experience or an experiment. The hyperparameters include a learning rate, a quantity of batch samples, a network structure hyperparameter (for example, a quantity of network layers (also referred to as a depth), a manner of interaction between network layers, a quantity of convolution kernels, a size of a convolution kernel, an activation function), and the like. The learning rate is used as a hyperparameter to control an update amplitude of a parameter weight of a model in a training process, and greatly affects a training speed and accuracy.

As shown in FIG. 1, a trained deep learning model may be used to perform inference on input data. In an inference phase, data in an actual application scenario is usually used as input data, and an inference result may be obtained through inference of the trained deep learning model. The inference phase is an actual application of the trained deep learning model, during which AI capabilities can be quickly used to resolve a technical problem. Currently, there are many AI application scenarios. The inference of the deep learning model can also be used in various application scenarios, for example, personnel identification for an access control system, video-based violence detection, and express waybill number detection and identification.

The foregoing uses training of a most typical deep learning model as an example for description. Training of other types of models is slightly different, but a principle is similar. In most cases, inference is performed on training data, and parameters in the model are adjusted based on an inference result, to obtain a parameter combination that ensures stable performance of the model.

In recent years, the big data industry and cloud computing technology have developed rapidly and become a hot topic in academia and enterprises. Big data has penetrated into almost all industries and has become an important production factor. As the data scale increases, other database management systems gradually evolve into cloud-native databases and cloud-native data warehouses that can process massive data, and can respond to queries of TBs of data within seconds.

To adapt to large-scale industry applications, indexing becomes a key technology to improve a query capability of a cloud-native data warehouse. A first generation cloud-native data warehouse uses fine-grained indexes (such as B-Trees) to accelerate query processing. However, B-Trees are limited by large storage and difficulty in scaling. In recent years, a scanning-oriented data processing policy has been used. This policy uses high sequential scanning bandwidth of modern storage devices. The cloud-native data warehouse generally distributes data to different cloud storage units through sharding. To facilitate subsequent quick retrieval in the cloud storage units, each storage unit records extreme values of each dimension, so as to implement quick filtering and pruning. This method has a filtering effect when the data is natural ordering. However, multi-dimensional data is not totally ordered. Therefore, in another manner of random sharding, data in each storage unit is usually far away from each other in a plurality of dimensions. This greatly reduces an effect of filtering using the extreme values.

In the data sharding method provided in another technology, a ranking key needs to be manually specified based on experience. An embodiment of this disclosure provides a data sharding method. In the method, adaptive sharding is performed on data in a database stored in a memory using an AI technology, such that when the data in the database is queried again using a query command, a scan cost can be reduced, and data skipping efficiency can be improved, thereby improving a query speed and query efficiency of the database.

In a possible implementation, the method provided in this embodiment of this disclosure may be used in a cloud scenario, that is, the database may be a cloud database. The cloud database is a database deployed in a virtual computing environment, and can implement advantages such as on-demand payment, on-demand scaling, high availability, and storage integration. The virtual computing environment may be a cloud platform. The cloud platform provides computing, network, and storage capabilities based on hardware resources and software resources. When a network “cloud” is used to remotely process and analyze massive data and return the data to users, the following features are provided: large-scale, distributed, virtualization, high availability, scalability, on-demand service, and security. A cloud computing platform can implement quick provisioning and release of the foregoing configurable computing resources at a relatively low management cost or with relatively low complexity of interaction between a user and a service provider.

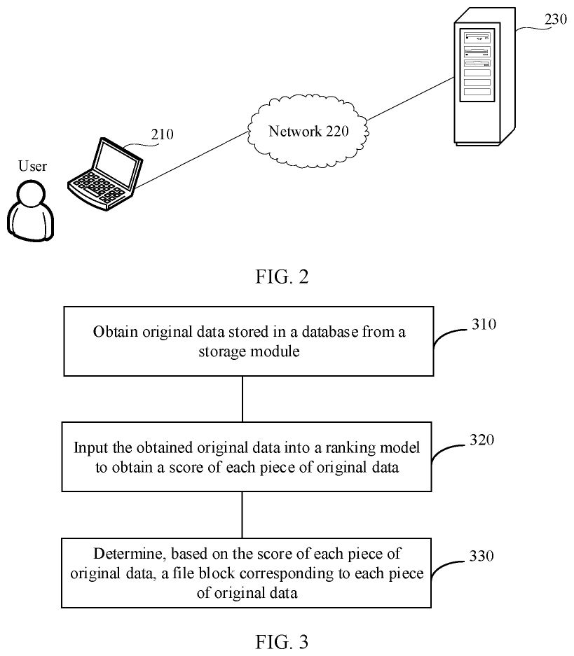

FIG. 2 is a schematic diagram of a disclosure scenario according to an embodiment of this disclosure. In this disclosure scenario, a client 210 and a cloud service system are shown. The cloud service system may include one or more servers 230 (one is shown in FIG. 2, but this is not limited in this disclosure). The client 210 is directly or indirectly connected to the server 230 using a network 220 (a wireless network or a wired network).

The client 210 is deployed on a user side, may be used as a client of a cloud database, and is configured to provide an interface for using a database service. The client 210 may be a virtual machine or a physical machine, and the physical machine may be a desktop computer, a notebook computer, a server, or the like. Alternatively, the client 210 may be software (such as a database client or a browser) deployed on a user-side device. This is not limited in this disclosure.

As a server end of the cloud database system, the server 230 is configured to manage the cloud database, for example, parse a query request for the cloud database, and provide data communication. The server 230 may be an independent physical server, a desktop computer, a notebook computer, or the like, may be a server cluster including a plurality of physical servers, or may be a computing node or a storage node (which may also be referred to as a data processing apparatus) in a distributed system. The server 230 may provide a service for the client 210, for example, a cloud database service. The server 230 may run a database, such as a PostgreSQL, MySQL, Oracle Database or a GaussDB (for Influx), to implement data storage and data management, and can conveniently perform operations such as adding, deleting, viewing, and modifying data.

The client 210 may communicate with the server 230 through the network 220, where the network 220 uses a standard communication technology and/or protocol. The network 220 includes but is not limited to any combination of a data center network, a storage area network (SAN), a local area network (LAN), a metropolitan area network (MAN), a wide area network (WAN), a mobile, wired or wireless network, a private network, or a virtual private network. In some implementations, a technology and/or a format that includes a Hypertext Markup Language (HTML), an Extensible Markup Language (XML), and the like are used to represent data exchanged through a network. In addition, common encryption technologies such as Secure Sockets Layer (SSL), transport layer security (TLS), virtual private network (VPN), and Internet Protocol Security (IPsec) can be used to encrypt all or some links. In other embodiments, a customized or dedicated data communication technology may be used to replace or supplement the foregoing data communication technology.

A user may send a data access request to the server 230 using the client 210, to access data in the server 230. A process in the server 230 may perform a series of read operations and/or write operations in response to the received data access request, to implement data storage, data management, and the like.

The following first describes in detail a data sharding method according to an embodiment of this disclosure with reference to FIG. 3. It should be understood that an example in FIG. 3 is merely intended to help a person skilled in the art understand this embodiment of this disclosure, instead of limiting this embodiment of this disclosure to a specific value or a specific scenario in the example shown in FIG. 3. Obviously, a person skilled in the art may make various equivalent modifications or variations based on the following example shown in FIG. 3. The modifications and changes also fall within the scope of embodiments of this disclosure.

FIG. 3 is a schematic flowchart of a data sharding method according to an embodiment of this disclosure. As shown in FIG. 3, the method may include steps 310 to 330. The following separately describes steps 310 to 330 in detail.
Step 310: Obtain original data stored in a database from a storage module.

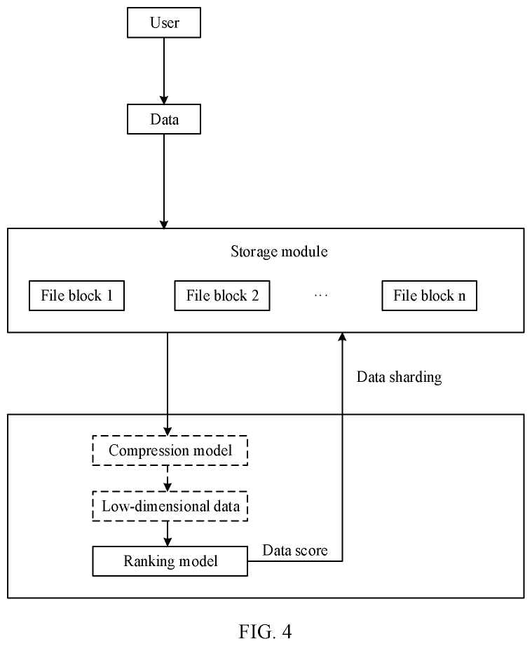

For example, in this embodiment of this disclosure, the original data stored in the database may be obtained from the storage module (for example, a disk). As shown in FIG. 4, the original data is data that has been stored by a user in the storage module.

The storage module (for example, a disk) includes a plurality of data blocks, and each data block includes a plurality of pieces of original data stored by the user in the storage module. Optionally, in some embodiments, the storage module may be an object storage service.

It should be understood that data sharding is to divide data into a plurality of file blocks according to a specific rule, and each file block may be processed or operated independently. Data sharding is usually performed to optimize an algorithm, improve processing efficiency, and reduce unnecessary computing and data transmission. In a database, data sharding is also referred to as data partitioning, and means that data is distributed to different physical locations or logical partitions according to a specific rule, to improve data access performance and a management capability. In a distributed system, data sharding may also be performed to balance load and improve system scalability. In a database, factors such as a data access frequency, a data size, and a system load usually need to be considered during data sharding. In a distributed system, problems such as load balancing, data replication, and fault recovery also need to be considered during data sharding.

The foregoing file block may also be referred to as a data block. It should be further understood that, in the database, data is mainly organized in a form of a table. Therefore, data in the database may also be referred to as table data, and each piece of data may be a row in a table.
Step 320: Input the obtained original data into a ranking model to obtain a score of each piece of original data.

In this embodiment of this disclosure, after the original data stored in the database in the storage module (for example, a disk) is obtained, as shown in FIG. 4, the original data may be input into a pre-trained ranking model, and the ranking model may output a score of each piece of original data. Specifically, the obtained original data may be used as input information of the ranking model, and the score of each piece of original data may be used as output information of the ranking model.
Step 330: Determine, based on the score of each piece of original data, a file block corresponding to each piece of original data.

In this embodiment of this disclosure, after the score of each piece of original data stored in the storage module is obtained, a plurality of pieces of original data may be sequentially divided into data blocks in descending order of the scores of the pieces of original data, that is, file blocks corresponding to the pieces of data in the original data are determined.

Specifically, because a size of each file block is fixed, once scores of all the pieces of original data are obtained, a manner of allocating the file blocks to the original data as a whole is determined. Therefore, as shown in FIG. 4, the plurality of pieces of original data may be re-divided into file blocks to which the plurality of pieces of original data belong based on a size of data that may be included in each file block and a score of each piece of original data.

In this embodiment of this disclosure, after the original data stored in the storage module is divided into file blocks to which the original data belongs, information of each file block needs to be updated, for example, information such as a maximum value (max) and a minimum value (min) of data maintained by each file block.

In the foregoing technical solution, because the ranking model is a ranking model that is trained in advance to minimize a scan cost, an optimal data sharding manner may be obtained using a score of original data obtained using the ranking model, such that the scan cost of querying the reordered data using a subsequent query command can be minimized, thereby improving the data skipping efficiency during data query, and improving the query speed and query efficiency of the database.

Optionally, in some embodiments, to improve inference efficiency of the ranking model, dimensionality reduction processing may be further performed on the obtained original data, to compress the high-dimensional original data into low-dimensional data. The low-dimensional data is used as input information of the ranking model, and output information of the ranking model is a score of the low-dimensional data. An optimal data sharding manner of the original data may be obtained based on the score of the low-dimensional data. In this way, dimensionality of the input information input to the ranking model is reduced, such that efficiency of obtaining a score using the ranking model can be improved. In addition, the compression model improves a capability of the model to adapt to high-dimensional data, and the compression model can naturally filter the high-dimensional data, thereby alleviating a problem of curse of dimensionality. It should be understood that the curse of dimensionality means that when dimensionality is excessively high, spatial proximity is weakened until the spatial proximity disappears, and an expected data sharding effect cannot be achieved using another spatial index structure.

In a possible implementation, as shown in FIG. 4, dimensionality reduction processing may be performed on the original data using a compression model, to obtain low-dimensional data, and then the obtained low-dimensional data is output to a pre-trained ranking model. The ranking model may output a score of each piece of original data.

The compression model is not specifically limited in this embodiment of this disclosure, provided that high-dimensional data can be compressed into low-dimensional data. In an example, a variational autoencoder (VAE) may be used as the compression model.

It should be understood that the VAE is a generation model. The VAE combines advantages of deep learning and a probability model, learns data distribution using an encoder (also referred to as a latent variable model) and a decoder (also referred to as a generator), and generates new data samples. A core idea of the VAE is to use a neural network to learn probability distribution of latent variables. These latent variables are intermediate steps of data generation. The neural network is trained to maximize data likelihood probability while keeping the distribution of latent variables close to a specified simple distribution (such as standard normal distribution). During training, the VAE uses variational inference and reparameterization techniques to optimize an objective function. The VAE first uses an encoder (also referred to as a latent variable model) to encode the input data into latent variables in latent space and then uses a decoder (also referred to as a generator) to decode the latent variables into original data. After the training is completed, the VAE can generate new data samples by sampling new latent variables from the latent space and decoding the new latent variables. These new data samples are similar to the training data in terms of data distribution, but these new data samples are new and unseen data.

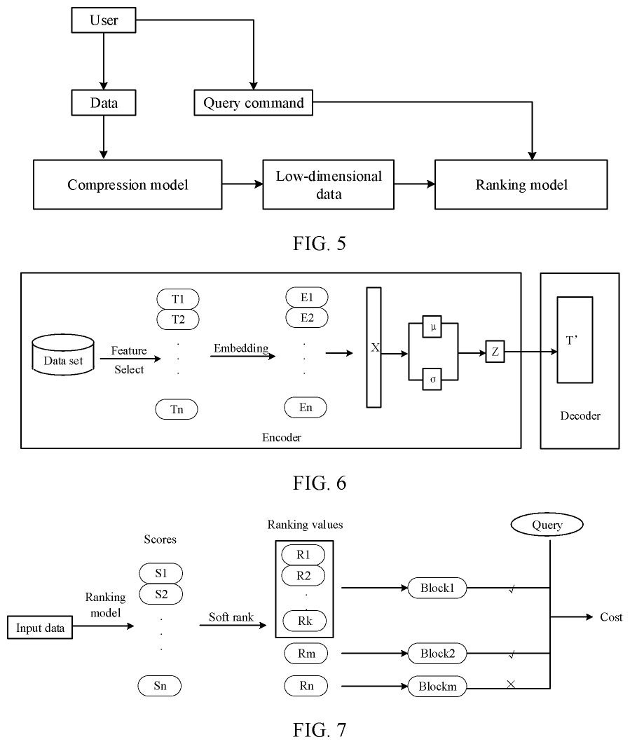

With reference to FIG. 5 to FIG. 7, the following describes in detail a training process of the compression model and the ranking model in FIG. 4. It should be understood that examples in FIG. 5 to FIG. 7 are merely intended to help a person skilled in the art understand this embodiment of this disclosure, instead of limiting this embodiment of this disclosure to specific values or specific scenarios in the examples shown in FIG. 5 to FIG. 7. Obviously, a person skilled in the art may make various equivalent modifications or variations based on the following examples shown in FIG. 5 to FIG. 7. The modifications and changes also fall within the scope of embodiments of this disclosure.

For example, as shown in FIG. 5, in this embodiment of this disclosure, the compression model and the ranking model may be trained based on original data in a storage module and/or a query command for the original data, such that the compression model can implement precise data compression on input multi-dimensional data, and the ranking model can score the input data, and re-rank the input data based on scores, such that a scan cost or scanning cost is the lowest.

For example, FIG. 6 is a schematic block diagram of training a compression model based on original data according to an embodiment of this disclosure. As shown in FIG. 6, a VAE is used as an example. The VAE includes an encoder and a decoder. A data set (sample data obtained after original data stored in a storage module is sampled) is used as an input of the encoder. The encoder compresses data in the data set into low-dimensional Gaussian distribution X using an encoder network. Specifically, it is assumed that the data in the data set is a high-dimensional vector, and the high-dimensional vector is represented by T (T=[d1, . . . , dn]). The high-dimensional vector T is calculated using a neural network of an encoder, that is, X=F_encode(T), to obtain the low-dimensional Gaussian distribution X. A mean value and a variance of each dimension of the low-dimensional Gaussian distribution are N (μₖ, δₖ²), and a latent variable Z is obtained from the multi-dimensional Gaussian distribution X. It should be understood that Z is the low-dimensional data obtained by compressing high-dimensional data in the data set.

In this embodiment of this disclosure, to implement precise compression of the high-dimensional data by the encoder, Z obtained by the encoder through compression further needs to be input to the decoder to obtain a decoded input T′, and the VAE attempts to perform fitting on T′, that is, reconstruct T. A loss function of the VAE includes two parts: a reconstruction loss and a KL divergence loss. Parameters of an encoder and a decoder included in the VAE are continuously adjusted based on the loss function until the loss function of the VAE meets a requirement, in which case it may be considered that the VAE has completed a training process.

It should be understood that the reconstruction loss measures a difference between a sample generated by the decoder and an original sample, and the KL divergence loss measures a difference between distribution in latent space and standard normal distribution.

For example, FIG. 7 is a schematic block diagram of training a ranking model for original data using a query command of original data according to an embodiment of this disclosure. As shown in FIG. 7, input data is used as input information of the ranking model and input to the ranking model, and the ranking model outputs a score corresponding to each piece of input data, for example, S1-Sn. The scores corresponding to the input data are non-differentiable during score ranking. As a result, a loss cannot be calculated subsequently. Therefore, in this embodiment of this disclosure, a Soft Rank operator is used to convert a score into a ranking index, that is, convert each score into a corresponding ranking value, for example, convert S1-Sn into R1-Rn. According to values of R1-Rn and configured sizes of file blocks, the file blocks respectively corresponding to the input data corresponding to R1-Rn are determined, and in this case, division of the file blocks to which the input data belongs is implemented once. Then, statistical information (that is, the Min and Max values) of each file block is recorded, and whether the file blocks need to be scanned is determined according to a query condition, so as to obtain a scan cost. In addition, parameters of the ranking model are continuously adjusted based on the scan cost, so as to continuously adjust ranking of the current input data until a calculated scan cost is the lowest. In this case, it may be considered that a training process of the ranking model has been completed, and the ranking model may be used in an inference process (for ranking the original data in FIG. 3).

It should be understood that a Soft Rank operator is converted into a linear programming problem on a permutation surface through a ranking operation, and because of use of a regular term, the Soft Rank operator can be used to calculate a ranking index, and the ranking index is differentiable.

It should be noted that the input data of the ranking model is not specifically limited in this embodiment of this disclosure. In an example, the input data of the ranking model may be directly the data set (sample data obtained after the original data stored in the storage module is sampled) in FIG. 6. In other words, the input data of the ranking model is uncompressed multi-dimensional data. In another example, the input data of the ranking model may also be dimensionality reduction data (for example, a latent variable Z) obtained after data in the data set is compressed in FIG. 6. In other words, the input data of the ranking model is low-dimensional data obtained after high-dimensional data is compressed.

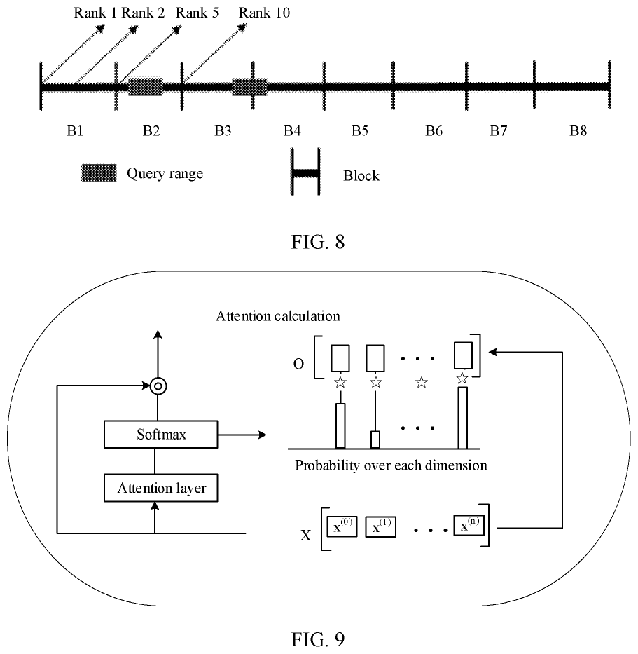

For example, FIG. 8 is a schematic diagram of calculating a scan cost for ranked data according to an embodiment of this disclosure. As shown in FIG. 8, a block is a range that needs to be scanned and queried and that is determined according to a query command. Herein, three blocks are touched by the query command: B2, B3, and B4. Because the data blocks have been determined, in this embodiment of this disclosure, all data that needs to be scanned may be extracted, and corresponding ranks are obtained. In FIG. 8, it is assumed that a fixed size of a block is 5 (that is, one block includes five pieces of data). In this case, rank 5 (R5) to rank 20 (R20) need to be scanned. The ranking difference score of each block is calculated using the following formula, so as to obtain a final scan cost. Finally, in this embodiment of this disclosure, a gradient descent algorithm may be used to minimize a calculated ScanCost, so as to continuously adjust a current data sharding manner until the ScanCost is the lowest.

$$ScanCost = {\sum }_{{R}_{i} ⊂ {B}_{k}} ( \vert {R}_{i} - {R}_{i - 1} \vert )$$

This embodiment of this disclosure provides a function of automatically adjusting a data sharding manner of data on a disk. Based on a query command and data provided by a user, an optimal data sharding manner of the data on the disk is automatically selected using an advanced AI method (for example, a trained ranking model), without the need for intervention of an administrator. Adjusting blocks of a table through automation can be used to obtain the fastest query performance without investing time in manual adjustment and table optimization.

In some embodiments, if a new data sharding manner determined in this embodiment of this disclosure can improve cluster performance, a table is automatically changed within several hours after a cluster is created, and impact on a query is minimized.

For example, FIG. 9 is a specific model architecture according to an embodiment of this disclosure. The model architecture may correspond to the foregoing compression model or ranking model. As shown in FIG. 9, the model architecture is an Attention Calculation model architecture, which is a model structure used when calculation of an Attention mechanism is performed.

It should be understood that the Attention mechanism is a technology widely used in deep learning tasks, especially in fields such as natural language processing, image recognition, and speech recognition. The Attention mechanism is used to combine input data with target tasks to better capture important features and patterns in data. The Attention mechanism is to learn a group of weights to weight features of different scales and semantics, so as to better extract important features. Intuitively, a Z-order value of a high-dimensional index and an attention network in deep learning seem to be two different concepts. The Z-order value is used for indexing and fast retrieval of spatial data, while the attention network is used to capture dependencies in sequential data. However, if functions and objectives of the Z-order value and the attention network are considered abstractly, some conceptual similarities can be found, dimensionality compression and information focusing, the Z-order value is used to compress information in high-dimensional space to one dimension such that efficient retrieval and calculation can be performed in low-dimensional space. The attention mechanism is to selectively focus on the most critical information in a high-dimensional information flow (which can be learned from both the load and data) and compress the information into a more useful form.

The Attention Calculation model architecture includes the following components:
1. Input layer: The input layer receives original input data, such as text, images, and audio.
2. Encoder: The encoder converts input data into vector representation for subsequent processing.
3. Decoder: The decoder decodes a vector representation output by the encoder into meaningful output data.
4. Attention mechanism: The Attention mechanism is introduced between the encoder and decoder to help a model better capture important features and patterns in input data.
5. Output layer: The output layer converts the data output by the decoder into a final output result.

In the Attention Calculation model architecture, calculation methods of the Attention mechanism usually include dot product, additive, multi-layer perceptron, and the like. Dot-product Attention is classified into Scaled Dot-Product Attention and Multi-Head Attention. Additive Attention includes Additive Attention and Location-Sensitive Attention. Multi-layer perceptron Attention includes Multi-Head Attention in a Transformer model.

A core idea of the Attention Calculation model architecture is to combine input data with a target task, and introduce the Attention mechanism to better capture important features and patterns in the data, so as to improve performance and accuracy of the model.

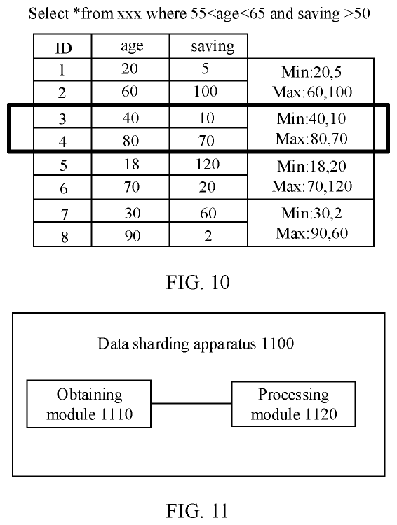

For example, FIG. 10 is a schematic diagram of False Positive reduction. FIG. 10 shows a visual description of a database query result, which is specifically scanning optimization of a data block based on the min-max values. Every two rows of data are regarded as a block. The minimum and maximum values of each block are provided. Using these min-max values, a query engine may determine whether to skip a block, thereby improving query efficiency. A query condition is to select records of users aged from 55 to 65 with savings greater than 50. In an example, a query engine can skip some blocks that do not meet the condition using the min-max values of the blocks. However, in this example, because a min-max range of each block overlaps a query condition, the query engine cannot determine which block is to be skipped. Therefore, each block needs to be scanned. More specifically, the second block (including data with ID 3 and data with ID 4) needs to be considered. Although no data in the block meets the query condition (for example, the age in ID 4 is 80, which exceeds the range of 55 to 65), because the age range (40 to 80) in the block has an intersection with the query condition, the query engine cannot determine that no data in the entire block meets the condition, and therefore the block cannot be skipped. This is a “false positive” situation. Herein, “false positive” means that it may be mistakenly considered that a block may include data that meets the query condition, although the block may actually not include such data. As a result, the query engine scans some blocks unnecessarily, which reduces the query efficiency.

High-dimensional indexing based on a learnable method is proposed, in which a machine learning model is used to predict ranking values of each row of data in a database. After the data blocks that need to be queried are determined, row IDs corresponding to the min-max values of each column are extracted from each scanned block. Based on the idea of contrastive learning, a model is trained to keep these predicted IDs away from the IDs of the scanned blocks as far as possible, so as to learn how to skip these blocks in future queries, thereby improving query efficiency.

$$L = - log \frac{Σ s i m ( r 1 , ri )}{Σ s i m ( r 1 , r k )}$$

The numerator is a distance between a row r1 and a point ri (an interval between two points coincides with a query range) that needs to be far away from, and the denominator is a distance between the point r1 and a nearby point rk (an interval between two points does not coincide with a query range).

The foregoing describes in detail the data sharding method provided in embodiments of this disclosure with reference to FIG. 1 to FIG. 10. The following describes in detail an apparatus embodiment of this disclosure with reference to FIG. 11 to FIG. 14A and FIG. 14B. It should be understood that the descriptions of the method embodiment correspond to the descriptions of the apparatus embodiment. Therefore, for parts not described in detail, refer to the foregoing method embodiment.

FIG. 11 is a schematic block diagram of a data sharding apparatus 1100 according to an embodiment of this disclosure. The apparatus 1100 may be implemented using software, hardware, or a combination thereof. The apparatus 1100 provided in this embodiment of this disclosure may implement the method procedure shown in FIG. 3 in embodiments of this disclosure. The apparatus 1100 includes an obtaining module 1110 and a processing module 1120. The obtaining module 1110 is configured to obtain a plurality of pieces of stored data. The processing module 1120 is configured to input the plurality of pieces of data into a ranking model to obtain a score corresponding to each piece of data, where input information of the ranking model includes the plurality of pieces of data, output information of the ranking model includes the score corresponding to each piece of data, the ranking model is determined based on the plurality of pieces of data and at least one query command, and the query command is used to query target data from the plurality of pieces of data. The processing module 1120 is further configured to determine, based on the score corresponding to each piece of data, file blocks respectively corresponding to the plurality of pieces of data.

Optionally, the apparatus 1100 further includes a training module. The obtaining module 1110 is further configured to obtain the at least one query command and sample data, where the sample data is obtained by sampling the plurality of pieces of stored data, and the training module is configured to obtain the ranking model through training based on the at least one query command and the sample data.

Optionally, the apparatus 1100 further includes a compression module. The compression module is configured to compress the plurality of pieces of data to obtain a plurality of corresponding dimensionality reduction data. The processing module 1120 is specifically configured to input the plurality of pieces of dimensionality reduction data into the ranking model to obtain the score corresponding to each piece of data.

Optionally, the compression module is specifically configured to input the plurality of pieces of data into a compression model to obtain the plurality of pieces of dimensionality reduction data, where input information of the compression model includes the plurality of pieces of data, and output information of the compression model includes the plurality of pieces of dimensionality reduction data.

Optionally, the training module is further configured to obtain the compression model through training based on the sample data.

Optionally, the compression model is a variational autoencoder VAE.

Optionally, the apparatus 1100 is used in a cloud management platform, the cloud management platform is configured to manage infrastructure that provides a cloud service, the infrastructure includes at least one cloud data center, at least one server is disposed in each cloud data center, and the at least one server is configured to train the ranking model and the compression model.

The apparatus 1100 herein may be embodied in a form of a functional module. The term “module” herein may be implemented in a form of software and/or hardware. This is not specifically limited.

For example, the “module” may be a software program, a hardware circuit, or a combination thereof that implements the foregoing functions. For example, the following uses the obtaining module 1110 as an example to describe an implementation of the obtaining module 1110. Similarly, for implementations of other modules such as the processing module 1120, the compression module, and the training module, refer to the implementation of the obtaining module 1110.

The obtaining module 1110 is used as an example of a software functional unit, and the obtaining module 1110 may include code running on a computing instance. The computing instance may include at least one of a physical host (computing device), a virtual machine, or a container. Further, there may be one or more computing instances. For example, the obtaining module 1110 may include code running on a plurality of hosts/virtual machines/containers. It should be noted that the plurality of hosts/virtual machines/containers used to run the code may be distributed in a same region, or may be distributed in different regions. Further, a plurality of hosts/virtual machines/containers used to run the code may be distributed in a same availability zone (AZ), or may be distributed in different AZs, and each AZ includes one data center or a plurality of geographically close data centers. A region may usually include a plurality of AZs.

Similarly, a plurality of hosts/virtual machines/containers used to run the code may be distributed in a same virtual private cloud (VPC), or may be distributed in a plurality of VPCs. Generally, one VPC is provided in one region. A communication gateway needs to be provided in each VPC for communication between two VPCs in the same region and between VPCs in different regions. The communication gateway implements interconnection between the VPCs.

The obtaining module 1110 is used as an example of a hardware functional unit, and the obtaining module 1110 may include at least one computing device, such as a server. Alternatively, the obtaining module 1110 may be implemented using an disclosure-specific integrated circuit (ASIC), a programmable logic device (PLD), or the like. The PLD may be a complex programmable logical device (CPLD), a field-programmable gate array (FPGA), a generic array logic (GAL), or any combination thereof.

A plurality of computing devices included in the obtaining module 1110 may be distributed in a same region, or may be distributed in different regions. The plurality of computing devices included in the obtaining module 1110 may be distributed in a same AZ, or may be distributed in different AZs. Similarly, the plurality of computing devices included in the obtaining module 1110 may be distributed in a same VPC, or may be distributed in a plurality of VPCs. The plurality of computing devices may be any combination of computing devices such as a server, an ASIC, a PLD, a CPLD, an FPGA, and a GAL.

Therefore, modules in the examples described in embodiments of this disclosure can be implemented by electronic hardware or a combination of computer software and electronic hardware. Whether the functions are performed by hardware or software depends on particular disclosures and design constraint conditions of the technical solutions. A person skilled in the art may use different methods to implement the described functions for each particular disclosure, but it should not be considered that the implementation goes beyond the scope of this disclosure.

It should be noted that, when the apparatus provided in the foregoing embodiment performs the foregoing method, division of the foregoing functional modules is merely used as an example for description. In actual disclosure, the foregoing functions may be allocated to different functional modules for implementation as required, that is, an internal structure of the apparatus is divided into different functional modules, so as to implement all or some of the functions described above. For example, the obtaining module 1110 may be configured to perform any step in the foregoing method, the processing module 1120 may be configured to perform any step in the foregoing method, the compression module may be configured to perform any step in the foregoing method, and the training module may be configured to perform any step in the foregoing method. Steps implemented by the obtaining module 1110, the processing module 1120, the compression module, and the training module may be specified as required. The obtaining module 1110, the processing module 1120, the compression module, and the training module separately implement different steps in the foregoing method, so as to implement all functions of the foregoing apparatus.

In addition, the apparatus provided in the foregoing embodiment and the method embodiment belong to a same concept. For a specific implementation process thereof, refer to the method embodiment. Details are not described herein again.

The method provided in embodiments of this disclosure may be performed by a computing device, and the computing device may also be referred to as a computer system, including a hardware layer, an operating system layer running above the hardware layer, and an disclosure layer running above the operating system layer. The hardware layer includes hardware such as a processing unit, a memory, and a memory control unit. Subsequently, functions and structures of the hardware are described in detail. The operating system is any one or more computer operating systems for implementing service processing through a process, for example, a Linux operating system, a Unix operating system, an Android operating system, an iOS operating system, or a Windows operating system. The disclosure layer includes disclosure programs such as a browser, an address book, word processing software, and instant messaging software. In addition, optionally, the computer system is a handheld device such as a smartphone, or a terminal device such as a personal computer. This is not particularly limited in this disclosure, provided that the method provided in embodiments of this disclosure can be used. For example, the method provided in embodiments of this disclosure may be executed by a computing device, or a functional module in the computing device that can invoke and execute a program.

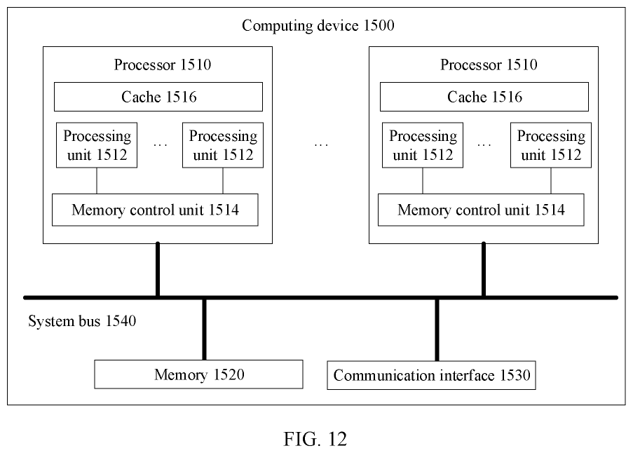

With reference to FIG. 12, the following describes in detail a computing device according to an embodiment of this disclosure.

FIG. 12 is a schematic diagram of an architecture of a computing device 1500 according to an embodiment of this disclosure. The computing device 1500 may be a server, a computer, or another device with a computing capability. The computing device 1500 shown in FIG. 12 includes at least one processor 1510 and a memory 1520.

It should be understood that a quantity of processors and a quantity of memories in the computing device 1500 are not limited in this disclosure.

The processor 1510 executes instructions in the memory 1520, such that the computing device 1500 implements the method provided in this disclosure. Alternatively, the processor 1510 executes the instructions in the memory 1520, such that the computing device 1500 implements the functional modules provided in this disclosure, to implement the method provided in this disclosure.

Optionally, the computing device 1500 further includes a communication interface 1530. The communication interface 1530 uses a transceiver module such as, but not limited to, a network interface card or a transceiver to implement communication between the computing device 1500 and other devices or communication network.

Optionally, the computing device 1500 further includes a system bus 1540. The processor 1510, the memory 1520, and the communication interface 1530 are separately connected to the system bus 1540. The processor 1510 can access the memory 1520 through the system bus 1540. For example, the processor 1510 can perform data reading/writing or code execution in the memory 1520 through the system bus 1540. The system bus 1540 is a peripheral component interconnect express (PCI) bus, an extended industry standard architecture (EISA) bus, or the like. The system bus 1540 may be classified into an address bus, a data bus, a control bus, or the like. For ease of representation, only one bold line indicates the bus in FIG. 12, but this does not mean that there is only one bus or only one type of bus.

In a possible implementation, a function of the processor 1510 is mainly to interpret instructions (or code) of a computer program and process data in computer software. The instructions of the computer program and the data in the computer software may be stored in the memory 1520 or a cache 1516.

Optionally, the processor 1510 may be an integrated circuit chip and has a signal processing capability. As an example rather than a limitation, the processor 1510 is a general-purpose processor, a digital signal processor (DSP), an ASIC, an FPGA, or another programmable logic device, a discrete gate or transistor logic device, or a discrete hardware component. The general-purpose processor is a microprocessor or the like. For example, the processor 1510 is a central processing unit (CPU).

Optionally, each processor 1510 includes at least one processing unit 1512 and a memory control unit 1514.

Optionally, the processing unit 1512 is also referred to as a core and is a most important component of the processor. The processing unit 1512 is made from monocrystalline silicon using a specific production process, and all calculations, acceptance commands, storage commands, and data processing of the processor are executed by the core. The processing unit independently runs program instructions, and increases a running speed of a program using a parallel computing capability. Various processing units have a fixed logical structure. For example, the processing unit includes logical units such as a level 1 cache, a level 2 cache, an execution unit, an instruction level unit, and a bus interface.

In an implementation example, the memory control unit 1514 is configured to control data exchange between the memory 1520 and the processing unit 1512. Specifically, the memory control unit 1514 receives a memory access request from the processing unit 1512, and controls access to the memory based on the memory access request. As an example rather than a limitation, the memory control unit is a device such as a memory management unit (MMU).

In an implementation example, each memory control unit 1514 performs addressing for the memory 1520 using a system bus. In addition, an arbiter (not shown in FIG. 12) is configured in the system bus, and the arbiter processes and coordinates contention-based access of a plurality of processing units 1512.

In an implementation example, the processing unit 1512 and the memory control unit 1514 communicate with and are connected to each other through a connection line such as an address line in a chip, to implement communication between the processing unit 1512 and the memory control unit 1514.

Optionally, each processor 1510 further includes a cache 1516, and the cache is a data exchange buffer (referred to as a cache). When the processing unit 1512 needs to read data, the processing unit 1512 first searches the cache for required data. If the data is found, the processing unit 1512 directly reads the data; or if the data is not found, the processing unit 1512 searches the memory for the data. Because the cache runs much faster than the memory, a function of the cache is to help the processing unit 1512 run faster.

The memory 1520 can provide running space for a process in the computing device 1500. For example, the memory 1520 stores a computer program (specifically, program code) used to generate the process. After the computer program is run by the processor to generate the process, the processor allocates corresponding storage space to the process in the memory 1520. Further, the storage space further includes a text segment, an initial data segment, an uninitialized data segment, a stack segment, a heap segment, and the like. The memory 1520 stores, in the storage space corresponding to the process, data generated during running of the process, for example, intermediate data or process data.

Optionally, the memory is also referred to as a memory, and a function of the memory is to temporarily store operation data in the processor 1510 and data exchanged with an external memory such as a hard disk. Provided that the computer runs, the processor 1510 invokes data that needs to be operated to the memory for an operation, and the processing unit 1512 sends a result after the operation is completed.

As an example rather than a limitation, the memory 1520 is a volatile memory or a non-volatile memory, or may include both a volatile memory and a non-volatile memory. The non-volatile memory is a ROM, a PROM, an EPROM, an EEPROM, or a flash memory. The volatile memory is a random-access memory (RAM) and serves as an external cache. Through example but not limitative description, many forms of RAMs may be used, for example, a static random access memory (SRAM), a dynamic RAM (DRAM), a synchronous DRAM (SDRAM), a double data rate SDRAM (DDR SDRAM), an enhanced SDRAM (ESDRAM), a synchronous-link DRAM (SLDRAM), and a direct Rambus RAM (DR RAM). It should be noted that the memory 1520 of the system and method described in this specification includes but is not limited to these and any other proper types of memories.

A structure of the foregoing example computing device 1500 is merely an example for description, and this is not limited in this disclosure. The computing device 1500 in this embodiment of this disclosure includes various types of hardware in a computer system in another technology. For example, the computing device 1500 further includes a memory other than the memory 1520, such as a magnetic disk memory. A person skilled in the art should understand that the computing device 1500 may further include another component required for implementing normal running. In addition, a person skilled in the art should understand that, based on a specific requirement, the computing device 1500 may further include a hardware component that implements another additional function. In addition, a person skilled in the art should understand that the computing device 1500 may alternatively include only a component required for implementing this embodiment of this disclosure, and does not need to include all the components shown in FIG. 12.

An embodiment of this disclosure further provides a computing device cluster. The computing device cluster includes at least one computing device. The computing device may be a server. In some embodiments, the computing device may also be a terminal device such as a desktop computer, a notebook computer, or a smartphone.

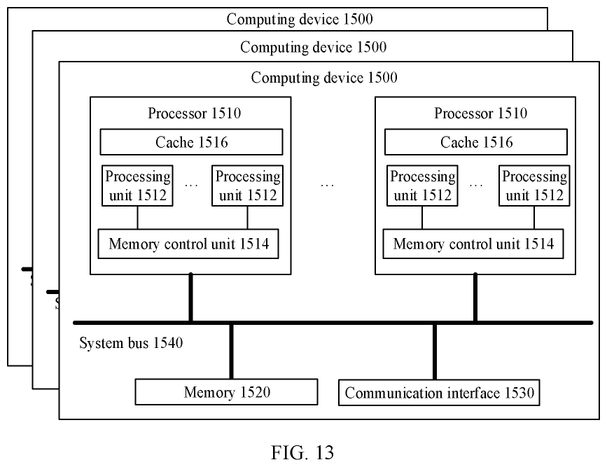

As shown in FIG. 13, the computing device cluster includes at least one computing device 1500. The memory 1520 in one or more computing devices 1500 in the computing device cluster may store a same instruction used to perform the foregoing method.

In some possible implementations, the memory 1520 in the one or more computing devices 1500 in the computing device cluster may also separately store some instructions used to perform the foregoing method. In other words, a combination of one or more computing devices 1500 may jointly execute instructions of the foregoing method.

It should be noted that the memories 1520 in different computing devices 1500 in the computing device cluster may store different instructions, which are respectively used to perform some functions of the foregoing apparatus. In other words, the instructions stored in the memories 1520 in different computing devices 1500 may implement functions of one or more modules in the foregoing apparatus.

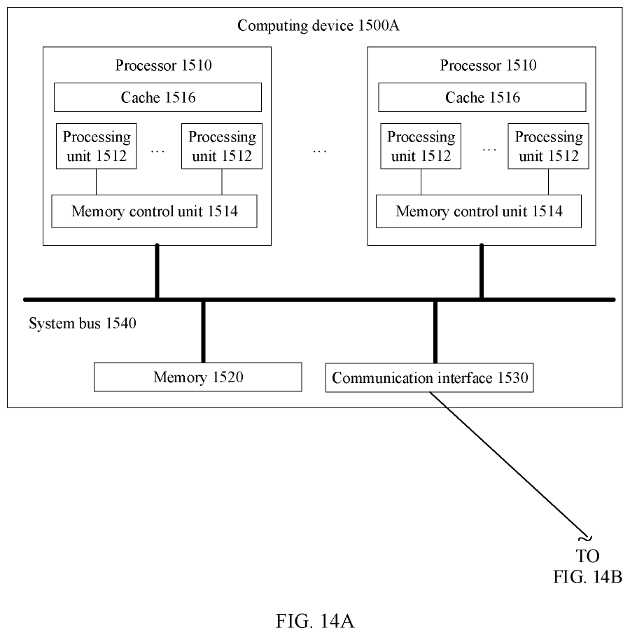

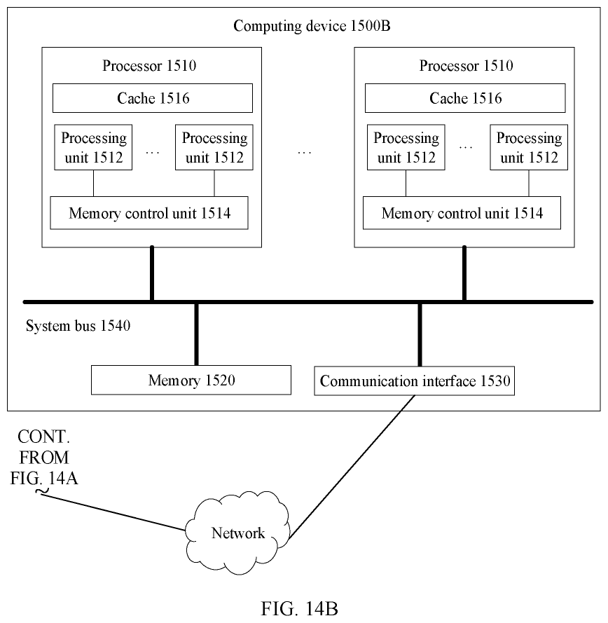

In some possible implementations, the one or more computing devices in the computing device cluster may be connected through a network. The network may be a wide area network, a local area network, or the like. FIG. 14A and FIG. 14B show a possible implementation. As shown in FIG. 14A and FIG. 14B, two computing devices 1500A and 1500B are connected through a network. Specifically, communication interfaces in the computing devices are connected to the network.

It should be understood that, in FIG. 14A and FIG. 14B, functions of the computing device 1500A may also be implemented by a plurality of computing devices 1500, and similarly, functions of the computing device 1500B may also be implemented by a plurality of computing devices 1500.

In this embodiment, a computer program product including instructions is further provided. The computer program product may be software or a program product that includes instructions and that can run on a computing device or be stored in any usable medium. When the computer program product runs on a computing device, the computing device performs the method provided above, or the computing device implements a function of the apparatus provided above.

In this embodiment, a computer-readable storage medium is further provided. The computer-readable storage medium may be any usable medium accessible by a computing device, or a data storage device such as a data center including one or more usable media. The usable medium may be a magnetic medium (for example, a floppy disk, a hard disk, or a magnetic tape), an optical medium (for example, a digital versatile disc (DVD)), a semiconductor medium (for example, a solid-state drive), or the like. The computer-readable storage medium includes instructions. When the instructions in the computer-readable storage medium are executed on a computing device, the computing device is enabled to perform the method provided above.

It should be understood that sequence numbers of the foregoing processes do not mean execution sequences in various embodiments of this disclosure. The execution sequences of the processes should be determined based on functions and internal logic of the processes, and should not be construed as any limitation on the implementation processes of embodiments of this disclosure.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular disclosures and design constraint conditions of the technical solutions. A person skilled in the art may use different methods to implement the described functions for each particular disclosure, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiment. Details are not described herein again.

In the several embodiments provided in this disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or another form.

The units described as separate parts may or may not be physically separate, and parts displayed as units may or may not be physical units, may be located in one location, or may be distributed on a plurality of network units. Some or all of the units may be selected based on actual requirements to achieve the objectives of the solutions in embodiments.

In addition, functional units in embodiments of this disclosure may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions in this disclosure essentially, or the part contributing to another technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this disclosure. The foregoing storage medium includes any medium that can store program code such as a Universal Serial Bus (USB) flash drive, a removable hard disk, a ROM, a RAM, a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method comprising:
obtaining a plurality of pieces of stored data;
inputting the plurality of pieces into a ranking model to obtain output information of the ranking model and comprising a score corresponding to each of the plurality of pieces, wherein the ranking model output information is based on the plurality of pieces and at least one query command, and wherein the query command is configured to query target data from the plurality of pieces; and
determining, based on the score, file blocks respectively corresponding to the plurality of pieces.

2. The method of claim 1, further comprising:
obtaining the at least one query command and sample data, wherein the sample data is based on sampling the plurality of pieces; and
obtaining the ranking model based on training using the at least one query command and the sample data.

3. The method of claim 1, further comprising:
compressing the plurality of pieces to obtain a plurality of dimensionality reduction data corresponding to the plurality of pieces; and
inputting the dimensionality reduction data into the ranking model to obtain the score.

4. The method of claim 3, wherein compressing the plurality of pieces to obtain the plurality of dimensionality reduction data comprises inputting the plurality of pieces into a compression model to obtain the plurality of dimensionality reduction data.

5. The method of claim 4, further comprising obtaining the compression model based on training using sample data.

6. The method of claim 4, wherein the compression model is a variational autoencoder (VAE).

7. The method of claim 1, further comprising managing an infrastructure to provide a cloud service.

8. An apparatus comprising:
a memory configured to store instructions; and
one or more processors coupled to the memory and configured to invoke the instructions to cause the apparatus to:
obtain a plurality of pieces of stored data; and
input the plurality of pieces into a ranking model to obtain output information of the ranking model comprising a score corresponding to each piece of the plurality of pieces, wherein output information is based on the plurality of pieces and at least one query command, and wherein the query command is configured to query target data from the plurality of pieces; and
determine, based on the score, file blocks respectively corresponding to the plurality of pieces.

9. The apparatus of claim 8, wherein the one or more processors is further configured to invoke the instructions to cause the apparatus to:
obtain the at least one query command and sample data, wherein the sample data is obtained by sampling the plurality of pieces; and
obtain the ranking model based on training using the at least one query command and the sample data.

10. The apparatus of claim 8, wherein the one or more processors is further configured to invoke the instructions to cause the apparatus to:
compress the plurality of pieces to obtain a plurality of dimensionality reduction data corresponding to the plurality of pieces; and
input the dimensionality reduction data into the ranking model to obtain the score.

11. The apparatus of claim 10, wherein the one or more processors is further configured to invoke the instructions to cause the apparatus to further compress the plurality of pieces to obtain the plurality of dimensionality reduction data by inputting the plurality of pieces into a compression model to obtain the dimensionality reduction data.

12. The apparatus of claim 11, wherein the one or more processors is further configured to invoke the instructions to cause the apparatus to obtain the compression model based on training using sample data.

13. The apparatus of claim 11, wherein the compression model is a variational autoencoder (VAE).

14. The apparatus of claim 8, wherein the apparatus is configured to manage infrastructure that provides a cloud service, wherein the infrastructure comprises at least one cloud data center, wherein the at least one cloud data center comprises at least one server, and wherein the at least one server is configured to train the ranking model and a compression model.

15. A computer program product comprising instructions that are stored on a non-transitory medium and that, when executed by one or more processors, cause an apparatus to:
obtain a plurality of pieces of stored data;
input the plurality of pieces into a ranking model to obtain output information of the ranking model comprising a score corresponding to each piece of the plurality of pieces, wherein output information is determined based on the plurality of pieces and at least one query command, and wherein the query command is configured to query target data from the plurality of pieces; and
determine, based on the score, file blocks respectively corresponding to the plurality of pieces.

16. The computer program product of claim 15, wherein the instructions, when executed by the one or more processors, further cause the apparatus to:
obtain the at least one query command and sample data, wherein the sample data is obtained by sampling the plurality of pieces; and
obtain the ranking model based on training using the at least one query command and the sample data.

17. The computer program product of claim 15, wherein the instructions, when executed by the one or more processors, further cause the apparatus to:
compress the plurality of pieces to obtain a plurality of dimensionality reduction data corresponding to the plurality of pieces; and
input the dimensionality reduction data into the ranking model to obtain the score.

18. The computer program product of claim 17, wherein compressing the plurality of pieces to obtain a plurality of dimensionality reduction data comprises inputting the plurality of pieces into a compression model to obtain the dimensionality reduction data.

19. The computer program product of claim 18, wherein the instructions, when executed by the one or more processors, further cause the apparatus to obtain the compression model based on training using sample data.

20. The computer program product of claim 18, wherein the compression model is a variational autoencoder (VAE).
